(19) United States
(12) Patent Application Publication
(10) Pub. No.: US 2025/0296354 A1
(43) Pub. Date: Sep. 25, 2025

(54) PRINTING APPARATUS AND PRINTING METHOD

(71) Applicant: SEIKO EPSON CORPORATION, Tokyo (JP)

(72) Inventor: Takamitsu KONDO, AZUMINO-SHI (JP)

(21) Appl. No.: 19/088,169

(22) Filed: Mar. 24, 2025

(30) Foreign Application Priority Data
Mar. 25, 2024 (JP) 2024-047708

(51) Int. Cl. B41J 3/407; B41J 11/00; B41J 29/393; D06P 5/30

(52) U.S. Cl. CPC B41J 3/4078; B41J 11/0025; B41J 11/008; B41J 29/393; D06P 5/30; B41J 2029/3935

(57) ABSTRACT

A printing apparatus according to the present disclosure provides a printing apparatus configured to discharge a liquid to a medium that is a fabric woven by using a first yarn in a first direction and a second yarn in a second direction intersecting the first direction, to perform printing, the printing apparatus including: a comparing unit configured to compare a size of a region occupied by the first yarn per unit area and a size of a region occupied by the second yarn in a surface of the medium at which the liquid is discharged, and a printing control unit configured to control printing based on image data, in which the printing control unit controls printing based on the image data such that, when the region occupied by the first yarn per unit area is greater than the region occupied by the second yarn, the amount of discharge of the liquid arranged in the first direction reduces as compared with when the region occupied by the first yarn per unit area is not greater than the region occupied by the second yarn.

The present application is based on, and claims priority from JP Application Serial Number 2024-047708, filed on Mar. 25, 2024, the disclosure of which is hereby incorporated by reference herein in its entirety.

### BACKGROUND

### 1. Technical Field

The present disclosure relates to a printing apparatus and a printing method.

### 2. Related Art

There is known a technique that discharges ink to print an image on a recording medium. In this regard, JP-A-2014-107687 discloses a technique configured to control the size of a dot of a liquid discharged to paper to suppress occurrence of bleed-through.

In recent years, there is an increasing demand for printing an image on a fabric. However, JP-A-2014-107687 discloses a technique that only pays attention to suppressing the occurrence of bleed-through during printing of an image on paper. For this reason, there is a demand for providing a printing technique suitable for discharging a liquid to perform printing on a fabric. Note that JP-A-2014-107687 mentions a process in which the fiber direction of the medium is taken into consideration. However, a fabric includes warp threads and wefts threads. Thus, when the fabric is used as a medium, it is not possible to uniquely determine which direction of the warp threads or the weft threads the fiber direction indicates. Thus, it can be said that, in JP-A-2014-107687, printing of an image on a fabric is not taken into consideration.

### SUMMARY

A printing apparatus according to the present disclosure provides a printing apparatus configured to discharge a liquid to a medium that is a fabric woven by using a first yarn in a first direction and a second yarn in a second direction intersecting the first direction, to perform printing, the printing apparatus including a comparing unit configured to compare a size of a region occupied by the first yarn per unit area and a size of a region occupied by the second yarn in a surface of the medium at which the liquid is discharged, and a printing control unit configured to control printing based on image data, in which the printing control unit controls printing based on the image data such that, when the region occupied by the first yarn per unit area is greater than the region occupied by the second yarn, an amount of discharge of the liquid arranged in the first direction reduces as compared with when the region occupied by the first yarn per unit area is not greater than the region occupied by the second yarn.

A printing method according to the present disclosure provides a method of performing printing by discharging a liquid to a medium that is a fabric woven by using a first yarn in a first direction and a second yarn in a second direction intersecting the first direction, the method including comparing a size of a region occupied by the first yarn per unit area and a size of a region occupied by the second yarn in a surface of the medium at which the liquid is discharged, and controlling printing based on image data, in which during the control of printing, printing based on the image data is controlled such that, when the region occupied by the first yarn per unit area is greater than the region occupied by the second yarn, an amount of discharge of the liquid arranged in the first direction reduces as compared with when the region occupied by the first yarn per unit area is not greater than the region occupied by the second yarn.

### BRIEF DESCRIPTION OF THE DRAWINGS

FIG. 1 is a schematic view illustrating the configuration example of a printing apparatus according to an embodiment.

FIG. 2 is a schematic view illustrating the configuration example of a carriage of the printing apparatus according to the embodiment.

FIG. 3 is a block diagram illustrating the configuration example of the printing apparatus according to the embodiment.

FIG. 4 is a schematic view illustrating warp threads and weft threads of a plain woven fabric.

FIG. 5 is a schematic view illustrating warp threads and weft threads of a fabric of satin weave.

FIG. 6 is a flowchart showing one example of a flow of processing concerning printing control in accordance with a result of comparison by a comparing unit.

FIG. 7 is a schematic view illustrating an example of printing when discharging from nozzles is restricted.

### DESCRIPTION OF EMBODIMENTS

Below, embodiment will be described with reference to the drawings. For the purpose of clarity of description, omission and simplification are made for the following description and drawings as appropriate. Furthermore, in each of the drawings, the same elements are denoted by the same reference characters, and description thereof will not be repeated as necessary.

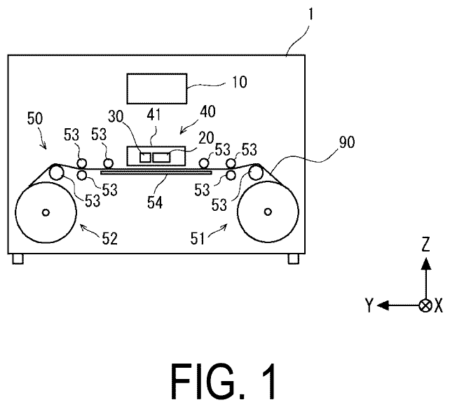

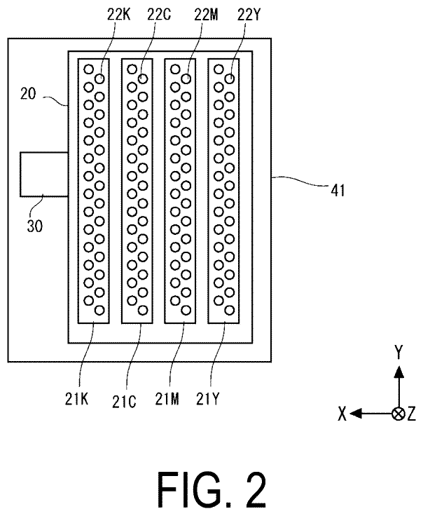

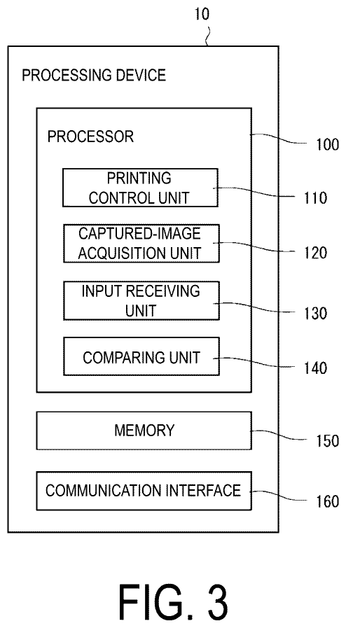

FIG. 1 is a schematic view illustrating the configuration example of a printing apparatus 1 according to the embodiment. In addition, FIG. 2 is a schematic view illustrating the configuration example of a carriage 41 of the printing apparatus 1. Furthermore, FIG. 3 is a block diagram illustrating the configuration of the printing apparatus 1. Note that, as for the coordinates indicated in FIGS. 1 and 2, the Z-axis direction is an up-down direction. The +Z direction is the upward direction. The X-axis direction is the front-rear direction. The −X direction is the frontward direction. The Y-axis direction is the left-right direction. The +Y direction is the leftward direction. The X-Y plane is a horizontal plane. Below, the printing apparatus 1 will be described with reference to FIG. 1 to FIG. 3 as appropriate.

The printing apparatus 1 is an inkjet printer configured to print an image on a medium 90. In the configuration example illustrated in FIG. 1, the printing apparatus 1 prints an image on the long medium 90 set in a state of being wound in a form of roll. In the present embodiment, the medium 90 is transported in the +Y direction in the drawing. For this reason, the Y-axis direction (in particular, the +Y direction) may be referred to as a transport direction. In addition, in the present embodiment, an image is printed on the medium 90 by a printing head unit 20 configured to be able to scan in the X-axis direction, as described later. Thus, the X-axis direction may be referred to as a scanning direction. The printing apparatus 1 performs printing on the medium 90 in accordance with print data generated on the basis of image data regarding an image to be printed on the medium 90.

In the present embodiment, the medium 90 is a fabric woven by using a first yarn in a first direction and a second yarn in a second direction intersecting the first direction. More specifically, the medium 90 is a fabric woven by using a warp thread (warp) and a weft thread (weft). That is, the first direction and the second direction described above are a direction of the warp thread and a direction of the weft thread, respectively. Thus, the first direction and the second direction basically intersect each other at a right angle. However, they may not strictly intersect each other at a right angle. In the present disclosure, the “intersect each other at a right angle” can include intersecting each other in a state of deviating from “completely intersect each other at a right angle” within a predetermined allowable range.

Furthermore, in the present embodiment, the medium 90 is set at the printing apparatus 1 such that the direction of the warp thread of the medium 90 extends along the transport direction (Y-axis direction). In other words, the medium 90 is set at the printing apparatus 1 such that the direction of the weft thread of the medium 90 extends along the scanning direction (X-axis direction). This can be also described such that the medium 90 is set at the printing apparatus 1 such that the direction of the warp thread of the medium 90 matches the transport direction, or the medium 90 is set at the printing apparatus 1 such that the direction of the weft thread of the medium 90 matches the scanning direction. However, these directions do not need to strictly match each other. That is, in the present disclosure, “two directions match each other” can include a state where these directions do not align and these directions can deviate from a state of “completely matching each other” within a predetermined allowable range.

The printing apparatus 1 includes the printing head unit 20, a camera 30, a scanning unit 40, a transport unit 50, a processing device 10, and the like. The processing device 10 generates print data on the basis of inputted image data, and controls the printing head unit 20, the scanning unit 40, and the transport unit 50 on the basis of the generated print data, thereby printing an image on the medium 90.

The printing head unit 20 discharges a dot of a liquid to the medium 90 in order to form an image on the medium 90, that is, in order to print an image on the medium 90. Specifically, the printing head unit 20 includes one or more heads each including a nozzle row including a plurality of nozzles arranged at constant intervals and configured to discharge an ink droplet.

In the present embodiment, as illustrated in FIG. 2, the printing head unit 20 includes a head 21K, a head 21C, a head 21M, and a head 21Y, as one example. FIG. 2 is a schematic view illustrating a carriage 41, which will be described later, as viewed from the lower surface. Here, the head 21K is a head configured to discharge black ink. The head 21C is a head configured to discharge cyan ink. The head 21M is a head configured to discharge magenta ink. The head 21Y is a head configured to discharge yellow ink. The head 21K includes a nozzle row including N (N is an integer) pieces of a plurality of nozzles 22K consecutively arranged in the Y-axis direction. Similarly, the head 21C includes a nozzle row including N pieces of a plurality of nozzles 22C consecutively arranged in the Y-axis direction. The head 21M also includes a nozzle row including N pieces of a plurality of nozzles 22M consecutively arranged in the Y-axis direction. The head 21Y also includes a nozzle row including N pieces of a plurality of nozzles 22Y consecutively arranged in the Y-axis direction. Note that the printing head unit 20 may include more heads in order to discharge more colors.

In this manner, in the present embodiment, the nozzle rows of the individual head 21K, head 21C, head 21M, and head 21Y are disposed along the transport direction (Y-axis direction). This can also be described such that the direction in which the nozzle rows of the individual head 21K, head 21C, head 21M, and head 21Y are arrayed matches the transport direction (Y-axis direction). However, these direction do not need to strictly match each other. In addition, in the present embodiment, the medium 90 is set at the printing apparatus 1 such that the direction of the warp thread of the medium 90 extends along the transport direction as described above. Thus, it can also be said that the medium 90 is set at the printing apparatus 1 such that the direction of the warp thread extends along the direction in which the nozzle row is arrayed. Note that, in FIG. 2, the nozzles of each of the heads are arranged in a staggered manner along a predetermined direction (Y-axis direction). However, the nozzles of each of the heads are only necessary to be arranged along a predetermined direction, and it may be possible to employ a configuration in which the nozzles of each of the heads are not arranged in a staggered manner. For example, the nozzles may be arranged in a straight line. Note that, in the following description, the head 21K, the head 21C, the head 21M, and the head 21Y may be collectively referred to as the head 21.

When being mounted at the carriage 41 and performing printing, the printing head unit 20 reciprocates in the X-axis direction in association with the carriage 41 that moves in the X-axis direction serving as the scanning direction. While moving in the X-axis direction, the head 21 included in the printing head unit 20 mounted at the carriage 41 discharges an ink droplet to the medium 90 supported by a platen 54 under control by a printing control unit 110 of the processing device 10, thereby forming a partial image on the medium 90. Printing of a partial image with movement of the printing head unit 20 in the X-axis direction is combined with transporting of the medium 90 in the Y-axis direction serving as the transport direction, whereby an image based on image data is printed on the medium 90.

The camera 30 images a front surface of the medium 90. More specifically, the camera 30 images the front surface of the medium 90 that serves as a surface at which a liquid (ink) is discharged. In other words, the camera 30 images the front surface of the medium 90 that serves as a surface opposed to the printing head unit 20. The camera 30 is only necessary to be able to image at least a portion of the front surface of the medium 90. In the present embodiment, before printing is performed, the camera 30 images a portion of the front surface of the medium 90 set at the printing apparatus 1 for the purpose of printing. More specifically, the camera 30 together with the printing head unit 20 is mounted at the carriage 41 as illustrated in FIG. 2. The camera 30 moves to a predetermined position due to movement of the carriage 41 before printing based on print data is performed, and images the medium 90 set at the platen 54 of the printing apparatus 1.

Note that, in the present embodiment, the camera 30 is mounted at the carriage 41. However, the camera may not need to be mounted at the carriage 41. That is, the camera 30 may be disposed at any given position where the camera can image the front surface of the medium 90 set at the printing apparatus 1 for the purpose of printing.

The scanning unit 40 and the transport unit 50 cause the medium 90 to relatively move with respect to the head 21 in accordance with control by the processing device 10. The scanning unit 40 includes the carriage 41 provided so as to be able to move, and also includes a movement mechanism for moving the carriage 41 and the like. Note that, for example, the movement mechanism includes a guiding shaft configured to guide movement of the carriage in the X-axis direction, and also includes a motor serving as a drive source for moving the carriage 41, and the like. The transport unit 50 includes a supply unit 51, an accommodation unit 52, a transport roller 53, and the platen 54. The supply unit 51 rotatably supports a reel in which the medium 90 is wound in a form of roll, and feeds the medium 90 to a position that is opposed to the printing head unit 20. The accommodation unit 52 rotatably supports a reel configured to wind up the medium 90, whereby the medium 90 on which printing has been completed is wound up. The transport roller 53 includes a driving roller configured to move the medium 90 in the transport direction at an upper surface of the platen 54, and a driven roller configured to rotate in association with movement of the medium 90. The platen 54 is provided so as to be opposed to the printing head unit 20, and supports the medium 90 being transported.

Next, the processing device 10 will be described with reference to FIG. 3. The processing device 10 includes a processor 100, a memory 150, and a communication interface 160, and has a function as a computer.

The memory 150 is comprised of a combination of a volatile memory and a non-volatile memory, for example. The memory 150 is used to hold a program to be executed by the processor 100, data used in various processes, and the like. The communication interface 160 is an interface used to communicate with other given devices. Note that, when communication with other devices is not performed, the processing device 10 may not include the communication interface 160.

The processor 100 reads out a program from the memory 150 to execute it. With this configuration, the processor 100 achieves the functions of the printing control unit 110, a captured-image acquisition unit 120, an input receiving unit 130, and a comparing unit 140, which will be described later. The processor 100 may be a microprocessor, a micro processor unit (MPU), a central processing unit (CPU), or the like, for example. The processor 100 may include a plurality of processors.

The printing control unit 110 performs a process for controlling printing based on image data. First, the printing control unit 110 performs a rendering process to image data inputted into the processor 100 to convert each pixel in the image data into RGB data. Here, “R” represents red, “G” represents green, and “B” represents blue. Once the RGB data is generated, the printing control unit 110 refers to a first look-up table to convert the RGB data for each pixel into CMYK data. Here, “C” represents cyan, “M” represents magenta, “Y” represents yellow, and “K” represents black. The CMYK data is ink amount data (data on density gradation value) for each color. In the first look-up table, colors made of a combination of R, G, and B are associated with respective ink amount data concerning individual ink. Once the ink amount data is generated, the printing control unit 110 performs a dot-decomposing process on the basis of a second look-up table. In the dot-decomposing process, the ink amount data is converted into dot ratio data indicating a usage ratio of an ink dot for each size. Here, four types of size, which are Null (blank dot), S (small dot), M (medium dot), and L (large dot), are used for the size of an ink dot, for example. In the second look-up table, the usage ratio of ink dots for individual sizes is set for the density gradation value (ink amount). Through the dot-decomposing process, the density gradation value is converted into a chance of occurrence of four types of dot, which are Null (blank dot), S (small dot), M (medium dot), and L (large dot). Next, the printing control unit 110 generates print data on the basis of the dot ratio data. The print data is a command group used to discharge ink from individual nozzles of the printing head unit 20, and is data for giving instructions as to a nozzle to be driven, and a dot size of ink discharged from this nozzle. Specifically, in order to generate print data, the printing control unit 110 performs halftone processing for determining, for each of the dot sizes, the presence or absence of generation of a dot at a pixel, on the basis of the dot ratio data concerning the ink dot generated through the dot-decomposing process. More specifically, the printing control unit 110 uses a dither method or error diffusion or the like to disperse dots of individual sizes on the basis of the dot ratio data, thereby representing an image (ink amount data) of multiple tones by the distribution of dots. With this configuration, the printing control unit 110 generates print data that is dot data in which one of four types of ink dot including a blank dot is designated for a pixel position. That is, there is generated the print data in which one of a plurality of ink dots including a blank dot and having different sizes is designated for each of the nozzles of each of the heads of the printing head unit 20. In this manner, the printing control unit 110 generates print data used to drive a nozzle of each of the heads of the printing head unit 20, on the basis of the image data. Note that the print data may include a command for controlling transport of the medium 90 and a command for controlling scanning of the printing head unit 20.

After generating the print data, the printing control unit 110 controls the printing head unit 20, the scanning unit 40, and the transport unit 50 to print an image on the medium 90. In particular, the printing control unit 110 controls discharge of a liquid (ink) from the printing head unit 20 on the basis of the print data, in order to print an image represented by the image data on the medium 90.

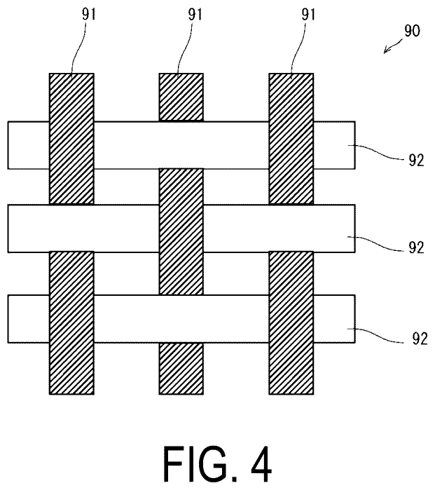

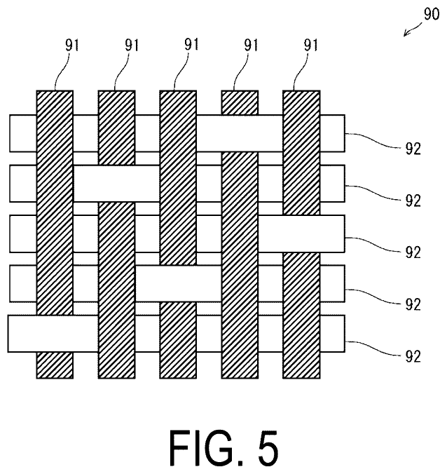

Incidentally, when the medium 90 is a fabric, it is preferable to perform printing in accordance with the characteristics of the medium 90. When ink is discharged to the fabric, the ink landing on the fabric spreads along a fiber such as a warp thread or a weft thread. In addition, there are various types of fabric depending on weaving manners. For example, FIG. 4 is a schematic view illustrating warp threads and weft threads of a plain woven fabric. In addition, FIG. 5 is a schematic view illustrating warp threads and weft threads of a satin-weave fabric. As illustrated in FIG. 4, in a case of plain weave, the percentage of warp threads 91 occupying per unit area of a front surface of the fabric and the percentage of weft threads 92 are equal to each to other. That is, the area of the warp threads 91 exposed at the front surface of the fabric and the area of the weft threads 92 are equal to each other. Furthermore, as illustrated in FIG. 5, in a case of satin weave, the percentage of warp threads 91 occupying per unit area of a front surface of the fabric is greater than the percentage of weft threads 92. That is, the area of the warp threads 91 exposed at the front surface of the fabric is greater than the area of the weft threads 92. In this manner, depending on weaving manners, a fabric may have an imbalance in terms of exposure of warp threads and weft threads. Thus, in a case of a fabric, the range of coloring by ink spreading along fibers varies depending on weaving manners. For example, when printing is performed to a fabric of satin weave in which the exposure of warp threads 91 is greater than the exposure of weft threads 92, coloring is less likely to spread in a direction of the weft thread 92 whereas the range of coloring is more likely to spread in a direction of the warp thread 91. Thus, even if dots of ink are not discharged consecutively in a direction of the warp thread 91, it is more likely to obtain continuous coloring in a direction of the warp thread 91. However, when dots of ink are not discharged consecutively in a direction of the weft thread 92, it is less likely to obtain coloring that continuous in a direction of the weft thread 92. Note that, in general, the distance between nozzles used for performing printing to a fabric is less than the thickness of a thread that constitutes the fabric.

In view of the consideration described above about printing to a fabric, the processing device 10 of the printing apparatus 1 according to the present embodiment restricts discharging of a dot of ink when printing is performed to the medium 90 that is a fabric. Below, in connection with this, the configuration of and the process of the processing device 10 will be further described.

The captured-image acquisition unit 120 acquires a captured image imaged by the camera 30. That is, the captured-image acquisition unit 120 acquires a captured image in which the front surface of the medium 90 is imaged. More specifically, the captured-image acquisition unit 120 acquires a captured image of the front surface of the medium 90 that is imaged by the camera 30 before printing is performed. Note that the captured-image acquisition unit 120 may control imaging by the camera 30. Furthermore, control of imaging may include control of movement of the carriage 41 for the purpose of capturing an image by the camera 30.

The input receiving unit 130 receives input from a user. In particular, the input receiving unit 130 receives, from a user, input regarding information for identifying the manner of weaving the medium 90. For example, the user inputs, into the printing apparatus 1, information for identifying the manner of weaving the medium 90 through an input device such as a keyboard or a pointing device. Note that the input device described above may be included in the printing apparatus 1, or may be included in another device coupled to the printing apparatus 1 in a manner that they can communicate with each other. In addition, information for identifying the manner of weaving the medium 90 is any given information that makes it possible to identify how warp threads and weft threads are woven to form the medium 90. Thus, information for identifying the manner of weaving the medium 90 may be information indicating the manner of weaving the medium 90 itself. Furthermore, when the printing apparatus 1 holds information in which identification information regarding the medium 90 is associated with information indicating the manner of weaving the medium 90 that is identified on the basis of this identification information, information for identifying the manner of weaving the medium 90 may be identification information regarding the medium 90.

The comparing unit 140 compares the size of a region occupied by warp threads per unit area in a surface of the medium 90 at which ink is discharged and the size of a region occupied by weft threads. More specifically, in the present embodiment, the comparing unit 140 compares the size of the area occupied by warp threads per unit area in a print surface of the medium 90 and the size of the area occupied by weft threads, on the basis of either the captured image that the captured-image acquisition unit 120 acquires or information that the input receiving unit 130 acquires. When this comparing process is performed on the basis of the captured image that the captured-image acquisition unit 120 acquires, the comparing unit 140 performs an image recognition process to the captured image, and identifies the area, per unit area, occupied by each of two types of threads (that is, warp threads and weft threads) having different directions. Then, the comparing unit 140 compares the two identified areas. In this manner, the comparing unit may compare the size of the region occupied by warp threads per unit area and the size of the region occupied by weft threads on the basis of the captured image. In addition, when the comparing process is performed by the comparing unit 140 on the basis of information acquired by the input receiving unit 130, the comparing unit 140 identifies a ratio of areas of two types of threads (that is, warp threads and weft threads) having different directions on the basis of the weaving manner identified on the basis of the acquired information. Note that, as illustrated in FIG. 4 or 5, by identifying the weaving manner of the medium 90, it is possible to identify the ratio of areas of warp threads and weft threads per unit area. In this manner, the comparing unit 140 may compare the size of the region occupied by warp threads per unit area and the size of the region occupied by weft threads on the basis of the information that the input receiving unit 130 acquires.

Note that, in the present embodiment, the comparing unit 140 is able to perform a comparing process using the captured image that the captured-image acquisition unit 120 acquires and also able to perform a comparing process using information that the input receiving unit 130 acquires. However, it may be possible to employ a configuration in which the comparing unit 140 is able to perform only one of these processes. Thus, the processing device 10 may not include either the captured-image acquisition unit 120 or the input receiving unit 130. In addition, when the comparing process using the captured image that the captured-image acquisition unit 120 acquires is not performed, the printing apparatus 1 may not include the camera 30. Note that, when the comparing process using the captured image that the captured-image acquisition unit 120 acquires is performed, information necessary for the comparing process is automatically acquired, which improves convenience of a user. In addition, when the comparing process using information that the input receiving unit 130 acquires is performed, the printing apparatus 1 may not include the camera 30 and also it is possible to skip the image recognition process for the captured image. This makes it possible to simplify the configuration of the printing apparatus 1.

Furthermore, in the present embodiment, the printing control unit 110 controls printing based on the image data in accordance with a result of comparison by the comparing unit 140. Specifically, when the range occupied by one thread of the warp thread and the weft thread per unit area is greater than the range occupied by the other thread per unit area, the printing control unit 110 controls printing such that the amount of discharge of ink arranged in a direction of the one thread reduces as compared with when the range occupied by one thread of the warp thread and the weft thread per unit area is not greater than the range occupied by the other thread per unit area. In other words, when the range occupied by the one thread per unit area is greater than the range occupied by the other thread per unit area, the printing control unit 110 controls printing such that the amount of discharge reduces as compared with when no difference exists between the ranges of them. Note that, when the ratio of areas of warp threads and weft threads in a fabric differs, the area of warp threads is greater than the area of weft threads in general. Thus, in the present embodiment in which the medium 90 is set at the printing apparatus 1 such that the direction of warp thread extends along a direction in which the nozzle row is arrayed, the area of threads in the transport direction (Y-axis direction) is greater than the area of threads in the scanning direction (X-axis direction) depending on the type of fabric of the medium 90.

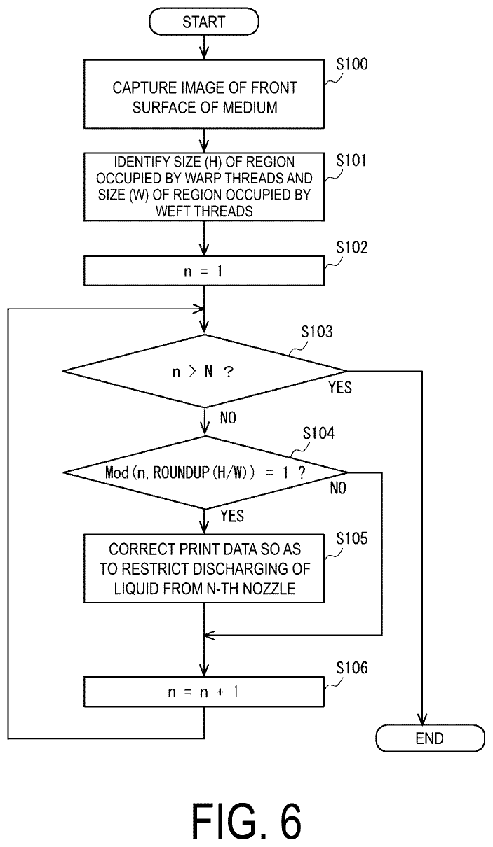

FIG. 6 is a flowchart showing one example of a flow of processing concerning printing control in accordance with a result of comparison by the comparing unit 140. In the example shown in FIG. 6, the printing control unit 110 corrects the print data generated on the basis of the image data in accordance with a result of comparison by the comparing unit 140. Through this flowchart, when the ratio of warp threads occupying the medium 90 per unit area is greater than the ratio of weft threads, use of a portion of the nozzles arranged continuously in a direction of the warp thread is restricted to perform printing. Below, with reference to FIG. 6, description will be made of a specific flow of a process concerning printing control in accordance with a result of comparison by the comparing unit 140.

In step S100, the camera 30 captures an image of the front surface of the medium 90 set at the printing apparatus 1. With this step, the captured-image acquisition unit 120 acquires a captured image taken by the camera 30.

Next, in step S101, the comparing unit 140 identifies the size H of the region occupied by warp threads per unit area in the print surface of the medium 90 and the size W of the region occupied by weft threads on the basis of the captured image acquired in step S100. In addition, the comparing unit 140 calculates a ratio (H/W) of the size H of the region of warp threads and the size W of the region of weft threads as an index for comparing the size H of the region of warp threads and the size W of the region of weft threads. Note that this ratio may be calculated in step S104 that will be described later. Furthermore, in the flowchart shown in FIG. 6, the comparing unit 140 uses the captured image acquired by the captured-image acquisition unit 120. However, as described above, in place of the captured image acquired by the captured-image acquisition unit 120, it may be possible to use information that the input receiving unit 130 acquires, to calculate the ratio (H/W) of the size H of the region of warp threads and the size W of the region of weft threads.

Next, in step S102, the printing control unit 110 sets “1” as a value of a parameter n used to designate a nozzle of the printing head unit 20. Note that the parameter n is used to designate one of the N pieces of nozzles that constitute a nozzle row. When n is one, a nozzle disposed at one end of the nozzle row is designated. As the value of n increases, nozzles are designated sequentially from one end of the nozzle row.

Next, in step S103, the printing control unit 110 determines whether or not the current value of n is greater than the number N of nozzles that each of the heads of the printing head unit 20 includes. When the value of n is equal to or less than N (No in step S103), the process moves to step S104. On the other hand, when the value of n is greater than N (YES in step S103), the process of this flowchart ends.

Once the process moves to step S104, the printing control unit 110 performs a process of determining whether or not to restrict discharging of a liquid (ink) from the nozzle designated by the value of n. Specifically, the printing control unit 110 determines whether or not the value of Mod (n, ROUNDUP (H/W)) is 1, as one example. That is, in this example, when the value of this Mod function is 1 (YES in step S104), the nozzle designated by the value of n corresponds to a nozzle from which discharging is to be restricted. Thus, in this case, the process moves to step S105. On the other hand, when the value of the Mod function is not 1 (NO in step S104), no restriction of discharging is applied to the nozzle designated by the value of n. Thus, in this case, the process skips step S105, and moves to step S106. Note that Mod (x, y) is a function for calculating a value of a remainder when x is divided by y. In addition, ROUNDUP (x) is a function that rounds up a value equal to or less than the fractional portion of the number to make the value of x into an integer. In the present example, as can be understood from the expression of the Mod function, when the size H of the range of wrap threads is greater than the size W of the range of weft threads, restriction of discharging is applied to nozzles selected at intervals from among the N pieces of nozzles that constitute the nozzle row arrayed in a direction of warp threads.

In step S105, the printing control unit 110 corrects the print data generated on the basis of the image data so as to restrict discharging of a liquid (ink) from a nozzle designated by the value n, that is, from the n-th nozzle that constitutes the nozzle row. Specifically, in the present embodiment, the printing control unit 110 deletes print data for controlling discharging from the n-th nozzle in the print data regarding the head 21K, the head 21C, the head 21M, and the head 21Y. With this configuration, the dot of a liquid corresponding to this n-th nozzle is forcibly made a blank dot. That is, discharging of a dot of a liquid from this n-th nozzle is disabled.

After step S105, the process moves to step S106. In step S106, the printing control unit 110 increases the value of the parameter n by one. After this, the process returns to step S103, and the processes described above are repeated.

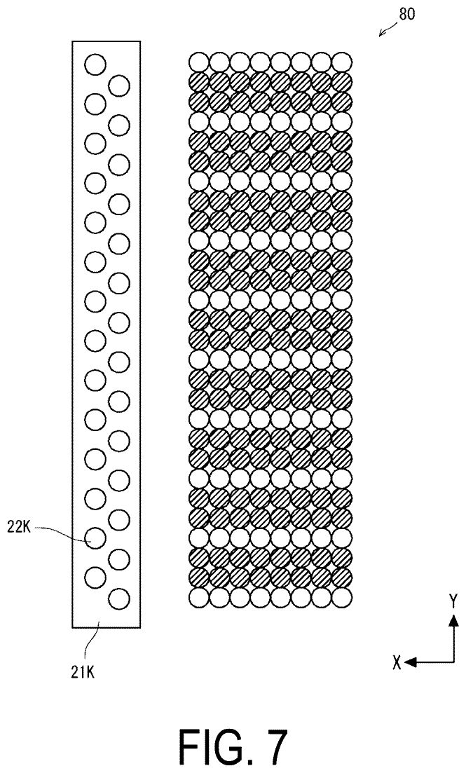

FIG. 7 is a schematic view illustrating an example of printing when discharging from nozzles is restricted. As one example, FIG. 7 schematically illustrates a dot group 80 formed on the medium 90 by the head 21K including N pieces of nozzles 22K. Note that FIG. 7 illustrates an example in a case of ROUNDUP (H/W)=3. In the dot group 80 illustrated in FIG. 7, hatched dots indicate dots that are actually discharged at the medium 90. On the other hand, dots without hatching indicate dots that are not discharged to the medium 90 through the process of the flowchart described above. The process of the flowchart described above restricts discharging of a dot of the liquid discharged from the nozzles arranged in a direction (Y-axis direction) of warp threads. Note that the medium 90 for which discharging is controlled as illustrated in FIG. 7 is a fabric in which more warp threads are exposed as illustrated in FIG. 5 or the like. Thus, even by restricting discharging from a portion of the nozzles in a direction (Y-axis direction) of warp thread, the ink spreads toward the direction of warp threads, and the medium 90 is colored without any interruption in the direction of warp threads.

In this manner, when exposure of threads in the first direction is greater than exposure of threads in the second direction, the printing control unit 110 controls printing such that the number of dots arranged in the first direction reduces. That is, the printing control unit 110 reduces the number of dots to control printing so as to eliminate a portion of the dots. Specifically, as for the nozzles serving as the target of restriction, the printing control unit 110 may replace the print data for instructing discharging of dots with print data for giving an instruction not to discharge dots. Note that, in the present embodiment, the printing control unit 110 controls printing so as to reduce the number of dots. However, the printing control unit 110 may control printing so as to reduce the size of the dot. That is, when exposure of threads in the first direction is greater than exposure of threads in the second direction, the printing control unit 110 may change the size of a dot indicated in the print data generated on the basis of the image data into a size smaller than this size for a portion of the nozzles that constitute the nozzle row.

These are descriptions of the printing apparatus 1 according to the embodiment. As described above, the printing apparatus 1 controls printing based on the image data such that, when the region occupied by the first yarn in the first direction is greater than the region occupied by the second yarn in the second direction, the amount of discharge of the ink arranged in the first direction reduces. This configuration makes it possible to reduce the consumption of ink. In addition, even when such a configuration is performed, ink discharged on the medium spreads in the first direction. Thus, it is possible to color the medium with this ink without any interruption in the first direction. That is, it is possible to form an image at the medium with sufficient quality while suppressing the consumption of ink. Furthermore, when printing is performed to a medium including fiber made of chemical such as polyester, ink is more likely to bleed through as compared with a medium made of natural fiber that can absorb moisture. It is effective to reduce the amount of discharge of a liquid in order to suppress the occurrence of bleed-through. However, this may lead to another drawback in which it is not possible to obtain sufficient color reproduction. In contrast, with the printing apparatus 1, a portion of the dots in a dot row disposed in a direction in which ink is more likely to spread is selected as the target of restriction of discharging. Thus, even if discharging is restricted, it is possible to expect ink to spread, and it is possible to suppress an influence on color reproduction. That is, it is possible to achieve both suppression of bleed-through and sufficient color reproduction. In this manner, with the printing apparatus 1, it is possible to provide a printing technique suitable for printing to a fabric woven by using a first yarn and a second yarn.

### First Modification Example

As described, in a case of chemical fiber, bleed-through of ink is more likely to occur. Thus, in a case where the medium 90 is a medium made of chemical fiber, the printing control unit 110 may increase the degree of reduction in the amount of discharge of a liquid arranged in the first direction, which is performed when the range occupied by the first yarn per unit area is greater than the range occupied by the second yarn, as compared with a case where the medium 90 is not a medium made of chemical fiber. Note that, more specifically, “the medium 90 is a medium made of chemical fiber” means that warp threads and weft threads are threads made of chemical fiber. Furthermore, “a case where the medium 90 is not a medium made of chemical fiber” specifically means that warp threads and weft threads are threads made of natural fiber. For example, in a case where the medium 90 is not a chemical fiber, it is determined in step S104 whether or not the value of Mod (n, ROUNDUP (H/W)) is 1. When the medium 90 is a chemical fiber, it is determined in step S104 whether or not the value of Mod (n, ROUNDUP (H/W)) is 1 or 2. In addition, when the medium 90 is a chemical fiber and the value of Mod (n, ROUNDUP (H/W)) is 1 or 2, the printing control unit 110 performs a process of step S105. In this manner, when the medium 90 is a medium made of chemical fiber, it may be possible to employ a configuration in which restriction of discharging is applied to more nozzles than that when the medium 90 is not a medium made of chemical fiber. Such a configuration makes it possible to suppress the occurrence of bleed-through of ink during printing to a medium made of chemical fiber.

Note that whether or not the medium 90 is a medium made of chemical fiber may be determined on the basis of input from a user as to the base material of the medium, or may be determined through the image recognition process performed to a captured image by the camera 30. That is, whether or not the medium 90 is a medium made of chemical fiber may be determined on the basis of input information that the input receiving unit 130 receives, or may be determined on the basis of a captured image that the captured-image acquisition unit 120 acquires.

### Second Modification Example

In addition, how much degree of restriction of discharging of a liquid from the nozzle is appropriate depends on the type of the medium 90, or the type of the liquid that is used, or the like. Thus, on the basis of a result of printing of a test pattern for the medium 90 serving as the target of printing, it may be possible to determine the degree of reduction in the amount of discharge of a liquid arranged in the first direction, which is performed when the range of the first yarn is greater than the range of the second yarn. Specifically, it may be possible to perform the following processes. When the range occupied by the first yarn per unit area is greater than the range of the second yarn, the printing control unit 110 performs control so as to print, on the medium 90, a plurality of test patterns having different amounts of discharge of a liquid arranged in the first direction. For example, the printing control unit 110 generates various types of print data including various degrees of reduction for print data generated on the basis of image data regarding a predetermined test pattern (for example, a filled-in image), and causes various type of test patterns to be printed on the medium 90 in accordance with these print data. Note that various types of print data having various degrees of reduction can be obtained, for example, by varying the number of candidates for the value that should satisfy the Mod (n, ROUNDUP (H/W)) in order to move to step S105 as described above. In this case, the number of nozzles for which discharging is restricted is counted, and the test patterns are printed. After this, the printing control unit 110 determines the degree of reduction in the amount of discharge applied when another image other than the test patterns is printed on the medium 90, in accordance with a result of printing of a plurality of test patterns. The printing control unit 110 may determine the degree of reduction in the amount of discharge applied when an image desired by a user is printed on the medium 90, for example, on the basis of input of an instruction concerning the degree of reduction from the user who checks the result of printing of the plurality of test patterns. In addition, the printing control unit 110 may perform the image recognition process to a scanned image obtained by scanning a plurality of printed test patterns, and evaluate a result of printing to determine the degree of reduction in the amount of discharge. By determining the degree of reduction in the amount of discharge on the basis of the result of printing of test patterns in this manner, it is possible to achieve more appropriate printing in accordance with types of the medium 90 or ink.

Note that the present disclosure is not limited to the embodiment described above and the modification examples thereof, and can be appropriately changed without departing from the main points. For example, in the embodiment described above, the processing device 10 of the printing apparatus 1 includes the printing control unit 110. However, a portion of or all of the functions of the printing control unit 110 may be achieved by another device (computer) coupled to the printing apparatus 1. In this case, the printing apparatus 1 and the other device may be collectively referred to as a printing apparatus.

In addition, in the present disclosure, the program includes a group of commands (or software code) for causing the computer to perform one or more functions described in the embodiment when the program is read by the computer. The program may be stored in a non-transitory computer-readable medium or a tangible storage medium. By way of example and not limitation, computer-readable media or tangible storage media include a random-access memory (RAM), a read-only memory (ROM), a flash memory, a solid-state drive (SSD) or other memory technologies, a CD-ROM, a digital versatile disk (DVD), a Blu-ray (trade name) disk or other optical disk storages, magnetic cassettes, magnetic tapes, a magnetic disk storage, or other magnetic storage devices. The program may be transmitted through a transitory computer-readable medium or a communication medium. By way of example and not limitation, the transitory computer-readable medium or a communication medium includes an electrical-type, an optical-type, an acoustical-type, or other types of propagation signal.

Some of or all of the embodiment and modification examples described above can also be described as the following Appendixes, but are not limited to the followings.

### Appendix 1

A printing apparatus configured to discharge a liquid to a medium that is a fabric woven by using a first yarn in a first direction and a second yarn in a second direction intersecting the first direction, to perform printing,
the printing apparatus including:
a comparing unit configured to compare a size of a region occupied by the first yarn per unit area and a size of a region occupied by the second yarn in a surface of the medium at which the liquid is discharged; and
a printing control unit configured to control printing based on image data, in which
the printing control unit controls printing based on the image data such that, when the region occupied by the first yarn per unit area is greater than the region occupied by the second yarn, an amount of discharge of the liquid arranged in the first direction reduces as compared with when the region occupied by the first yarn per unit area is not greater than the region occupied by the second yarn.

### Appendix 2

The printing apparatus according to Appendix 1 further includes:
a captured-image acquisition unit configured to acquire a captured image in which the surface of the medium is imaged, in which
the comparing unit compares the size of the region occupied by the first yarn per unit area and the size of the region occupied by the second yarn on a basis of the captured image.

### Appendix 3

The printing apparatus according to Appendix 1 or 2 further includes:
an input receiving unit configured to receive input from a user in connection with information for identifying a manner of weaving the medium, in which
the comparing unit compares the size of the region occupied by the first yarn per unit area and the size of the region occupied by the second yarn on a basis of the information.

### Appendix 4

The printing apparatus according to any one of Appendixes 1 to 3 is configured such that
when the region occupied by the first yarn per unit area is greater than the region occupied by the second yarn, the printing control unit controls printing based on the image data so as to reduce the number of dots arranged in the first direction, as compared with when the region occupied by the first yarn per unit area is not greater than the region occupied by the second yarn.

### Appendix 5

The printing apparatus according to any one of Appendixes 1 to 4 is configured such that
when the medium is a medium including a chemical fiber, the printing control unit increases a degree of reduction in an amount of discharge of the liquid arranged in the first direction performed when the region occupied by the first yarn per unit area is greater than the region occupied by the second yarn, as compared with when the medium is not a medium including a chemical fiber

### Appendix 6

The printing apparatus according to any one of Appendixes 1 to 5 is configured such that
when the region occupied by the first yarn per unit area is greater than the region occupied by the second yarn, the printing control unit performs control on a basis of image data regarding a test pattern so as to print, at the medium, a plurality of the test patterns having different amounts of discharge of the liquid arranged in the first direction, and
the printing control unit determines a degree of reduction in an amount of discharge of the liquid arranged in the first direction applied when another image other than the test pattern is printed at the medium, in accordance with a result of printing of a plurality of the test patterns.

### Appendix 7

Provided is a method of performing printing by discharging a liquid to a medium that is a fabric woven by using a first yarn in a first direction and a second yarn in a second direction intersecting the first direction,
the method including:
comparing a size of a region occupied by the first yarn per unit area and a size of a region occupied by the second yarn in a surface of the medium at which the liquid is discharged; and
controlling printing based on image data, in which
during the control of printing, printing based on the image data is controlled such that, when the region occupied by the first yarn per unit area is greater than the region occupied by the second yarn, an amount of discharge of the liquid arranged in the first direction reduces as compared with when the region occupied by the first yarn per unit area is not greater than the region occupied by the second yarn.

What is claimed is:

1. A printing apparatus configured to discharge a liquid to a medium that is a fabric woven by using a first yarn in a first direction and a second yarn in a second direction intersecting the first direction, to perform printing,
the printing apparatus comprising:
a comparing unit configured to compare a size of a region occupied by the first yarn per unit area and a size of a region occupied by the second yarn in a surface of the medium at which the liquid is discharged; and
a printing control unit configured to control printing based on image data, wherein
the printing control unit controls printing based on the image data such that, when the region occupied by the first yarn per unit area is greater than the region occupied by the second yarn, an amount of discharge of the liquid arranged in the first direction reduces as compared with when the region occupied by the first yarn per unit area is not greater than the region occupied by the second yarn.

2. The printing apparatus according to claim 1 further comprising:
a captured-image acquisition unit configured to acquire a captured image in which the surface of the medium is imaged, wherein
the comparing unit compares the size of the region occupied by the first yarn per unit area and the size of the region occupied by the second yarn on a basis of the captured image.

3. The printing apparatus according to claim 1 further comprising:
an input receiving unit configured to receive input from a user in connection with information for identifying a manner of weaving the medium, wherein
the comparing unit compares the size of the region occupied by the first yarn per unit area and the size of the region occupied by the second yarn on a basis of the information.

4. The printing apparatus according to claim 1, wherein
when the region occupied by the first yarn per unit area is greater than the region occupied by the second yarn, the printing control unit controls printing based on the image data so as to reduce the number of dots arranged in the first direction, as compared with when the region occupied by the first yarn per unit area is not greater than the region occupied by the second yarn.

5. The printing apparatus according to claim 1, wherein
when the medium is a medium including a chemical fiber, the printing control unit increases a degree of reduction in an amount of discharge of the liquid arranged in the first direction performed when the region occupied by the first yarn per unit area is greater than the region occupied by the second yarn, as compared with when the medium is not a medium including a chemical fiber.

6. The printing apparatus according to claim 1, wherein
when the region occupied by the first yarn per unit area is greater than the region occupied by the second yarn, the printing control unit performs control on a basis of image data regarding a test pattern so as to print, at the medium, a plurality of the test patterns having different amounts of discharge of the liquid arranged in the first direction, and
the printing control unit determines a degree of reduction in an amount of discharge of the liquid arranged in the first direction applied when another image other than the test patterns is printed at the medium, in accordance with a result of printing of the plurality of test patterns.

7. A method of performing printing by discharging a liquid to a medium that is a fabric woven by using a first yarn in a first direction and a second yarn in a second direction intersecting the first direction,
the method including:
comparing a size of a region occupied by the first yarn per unit area and a size of a region occupied by the second yarn in a surface of the medium at which the liquid is discharged; and
controlling printing based on image data, wherein
during the control of printing, printing based on the image data is controlled such that, when the region occupied by the first yarn per unit area is greater than the region occupied by the second yarn, an amount of discharge of the liquid arranged in the first direction reduces as compared with when the region occupied by the first yarn per unit area is not greater than the region occupied by the second yarn.
